(19) United States
(12) Patent Application Publication
(10) Pub. No.: US 2016/0321593 A1
(43) Pub. Date: Nov. 3, 2016

(54) CLINICAL QUALITY PERFORMANCE MANAGEMENT

(71) Applicant: Hewlett-Packard Development Company, L.P., Fort Collins, CO (US)

(72) Inventors: Dan George Gonos, Roseville, CA (US); Edward Dinardo, Underhill, VT (US); James Griffith, Camp Hill, PA (US)

(21) Appl. No.: 14/701,428

(22) Filed: Apr. 30, 2015

(51) Int. Cl. G06Q 10/06; G06Q 50/22; G06F 19/00

(52) U.S. Cl. CPC G06Q 10/06395; G06F 19/327; G06Q 50/22; G06Q 10/06393

(57) ABSTRACT

Example implementations relate to clinical quality measure (CQM) reporting. For example, a computing device may include a processor. The processor may receive CQM data and may receive encounter data associated with at least one medical encounter. The processor may identify that the CQM data is associated with the encounter data and may determine that the CQM data and the encounter data fulfill a set of criteria defined by a clinical quality performance management program. The processor may generate a report identifying potential eligibility for an incentive or disincentive based on the CQM data and the encounter data.

### BACKGROUND

Health care reform has been dominating U.S. headlines for many years. Some objectives of health care reform have been to improve medical care, improve population health, and reduce health care costs through the use of health information technology. These objectives may be measured using various indicators such as clinical quality measures, which are ratio-based indicators of process, access, outcome, and/or patient experience during a medical encounter that make it possible to assess the capability and quality of care of various health care providers.

### BRIEF DESCRIPTION OF THE DRAWINGS

Some examples of the present application are described with respect to the following figures:

FIG. 1 is a block diagram of an example system for generating a report relating to clinical quality measures;

FIG. 2 is a block diagram of an example computing device for creating a report relating to clinical quality measures; and

FIG. 3 is a flowchart of an example method for generating a report relating to clinical quality measures.

### DETAILED DESCRIPTION

As described above, health care reform objectives include improving medical care, improving population health, and reducing health care costs through the use of health information technology. Clinical quality measures (CQMs) are ratio-based indicators of process, access, outcome, and/or patient experience during a medical encounter that allow for the assessment of capability and quality of care of various health care providers. The 2009 federal Health Information Technology for Economic and Clinical Health (HITECH) Act established a standardized manner of defining CQMs that any certified Electronic Health Record (EHR) system can calculate for a health care provider. These electronic CQMs (eCQMs) may be reported by EHRs in an industry standard extensible markup language (XML) format known as Quality Reporting Data Architecture (QRDA). This ability to generate QRDA reports, at both an individual patient level and an aggregate provider level, is important to the health care industry. The reports provide a standardized way for institutions, such as health benefit payers and governments (e.g., local, state, and/or federal governments) to evaluate quality of care for population health and quality of care incentives such as Risk Sharing Models. For example, under the 2009 Federal HITECH Act, Medicaid programs are eligible to apply for Federal funding towards implementing Pay for Performance incentives that motivate health care providers to perform in a particular manner based on eCQM data that is collected from provider EHR systems. Such programs focus on providing incentives as well as disincentives to providers that motivate increased quality of medical care and discourage poor quality of medical care, instead of rewarding quantity of medical care. An incentive may refer to any benefit with which an entity may be rewarded based on quality of medical care, where the incentive may be based on a set of criteria to be met in order for the incentive to be rewarded. A disincentive may refer to any detriment with which an entity may be penalized based on quality of medical care, where the disincentive may be based on the set of criteria to be met in order for an incentive to be rewarded.

To aid in the process of obtaining these incentives, a reporting tool is disclosed herein which provides automated reporting of CQMs to aid in clinical quality performance management. The reporting tool may be used by and/or incorporated in existing systems of various health care payer entities to help manage clinical quality performance. A health care payer may be any entity paying health care benefits on behalf of one or more individuals (e.g., patients). The reporting tool may report clinical quality performance such that any incentives and/or disincentives may be received. For example, poor quality of care may result in a provider having to refund previous incentives and/or receive disincentives, acceptable quality of care may result in nothing being gained or lost by a provider, and more than acceptable quality of care may result in a bonus and/or incentive being received by the provider. The examples explained throughout this description describe incentives being received. However, one of ordinary skill in the art will appreciate that receiving incentives may also include receiving disincentives. The reporting tool may receive CQM data and encounter data associated with at least one medical encounter. The CQM data may include any data associated with CQMs. In some examples, the CQM data may include eCQM data. The encounter data may include any data associated with at least one medical encounter, which may refer to any encounters a patient may have with a health care provider, such as a medical procedure (e.g., surgery, laboratory work, etc.). In some examples, the encounter data may include data associated with an episode of care, which may refer to a collection of related medical encounters. In some examples, the encounter data may include claim data that may be any data associated with a medical claim, where the medical claim may be any claim sent to a health care payer requesting that the health care payer pay for any medical encounters specified on the medical claim. In some examples, the CQM data received may be imported and transformed such that it may be used by a particular clinical quality performance management program and/or analytics program. The reporting tool may associate CQM data with the corresponding encounter data received and may determine whether the data fulfills a set of criteria. The set of criteria may be based on a particular clinical quality performance management program identifying criteria to be met in order to receive an incentive. A report may be generated specifying any data for which the set of criteria has been met. This reporting tool may comply with Federal HIPAA privacy regulations.

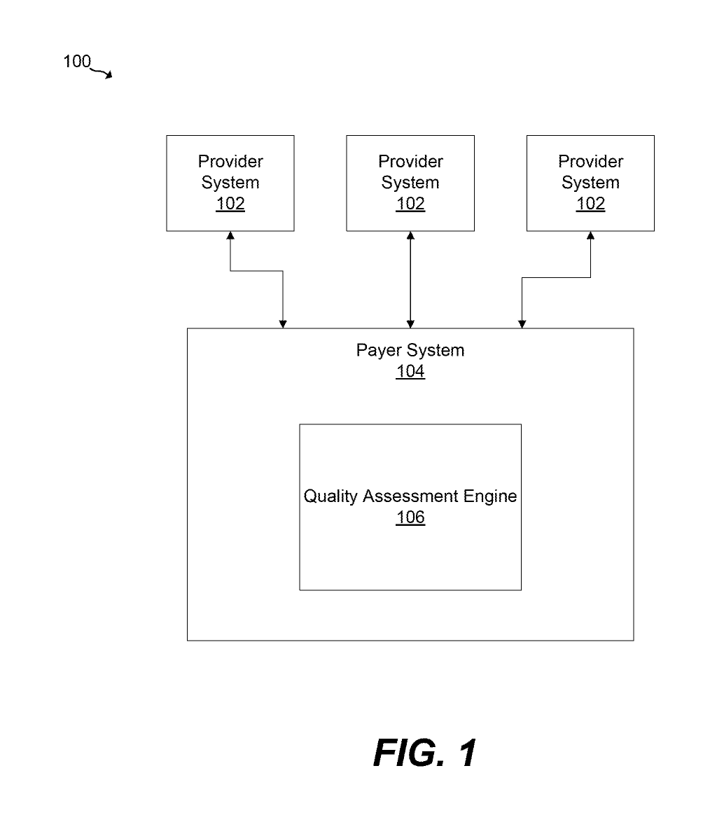

Referring now to the figures, FIG. 1 is a block diagram of an example system 100 for generating a report relating to CQMs. System 100 may include payer system 104, which may be any suitable system that may include any suitable server, such as a web-based server, a local area network server, a cloud-based server, and the like. Payer system 104 may be any suitable system for assessing CQMs and medical encounters using quality assessment engine 106. For example, payer system 104 may be a system associated with an insurance company. Payer system 104 may receive CQM data as well as encounter data associated with at least one medical encounter from any of the provider systems 102. Each provider system 102 may be any system associated with any entity providing CQM data and/or encounter data, such as a health care provider computing device, a computing device of a patient, and the like. Payer system 104 may identify that the CQM data is associated with the encounter data, and quality assessment engine 106 of payer system 104 may determine that the CQM data and the encounter data fulfill a set of criteria defined by a clinical quality performance management program. Quality assessment engine 106 may be any suitable engine configured to define and apply a set of criteria based on a clinical quality performance management program offering incentives or disincentives based on compliance with preferred performance standards. For example, quality assessment engine 106 may define various rules associated with a clinical quality performance management program such that CQM data and encounter data may be evaluated based on those rules to determine whether any medical encounters associated with the CQM data and/or encounter data warrant an incentive or disincentive from the clinical quality performance management program. Payer system 104 may generate a report identifying any potential eligibility for an incentive or disincentive based on the CQM data and the encounter data. The report may be sent to the appropriate institution such that payer system 104 may receive any incentives or disincentives for which eligibility is established from that institution.

Payer system 104 and provider systems 102 may be in communication with each other directly or over a network, which may be any suitable network, such as an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks. Each provider system 102 may be a computing device associated with a particular health care provider and/or patient. For example, provider system 102 may be a computing device through which a health care provider and/or a patient may send encounter data and/or CQM data to a particular payer system, such as payer system 104.

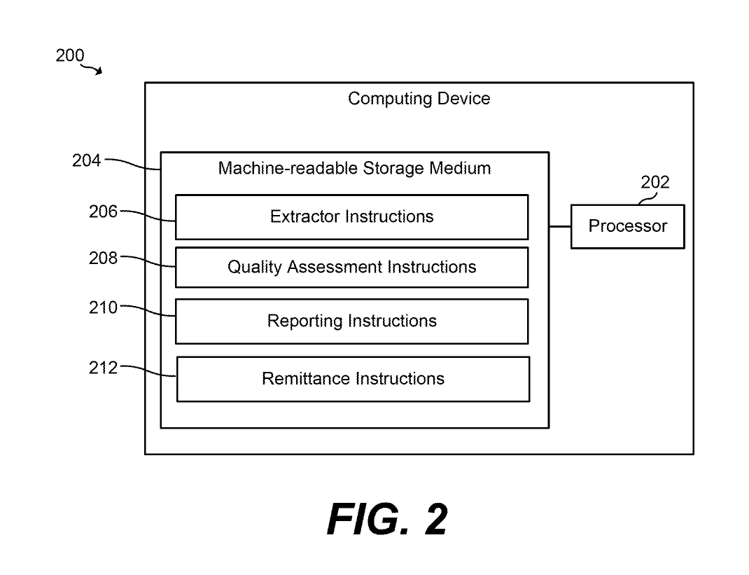

FIG. 2 is a block diagram of an example computing device 200 for creating a report relating to CQMs. Computing device 200 may be a server (e.g., a server within payer system 104 of FIG. 1) that may create a report identifying potential eligibility for an incentive or disincentive based on CQM data and encounter data received.

Computing device 200 may be, for example, a web-based server, a local area network server, a cloud-based server, a notebook computer, a desktop computer, an all-in-one system, a tablet computing device, a mobile phone, an electronic book reader, a printing device, or any other electronic device suitable for creating a report relating to CQMs. Computing device 200 may include a processor 202 and a machine-readable storage medium 204. Computing device 200 may receive CQM data and encounter data associated with at least one medical encounter, generate an association between the data, identify that the data fulfill a set of criteria, and create a report identifying potential eligibility for an incentive or disincentive based on the data.

Processor 202 is a tangible hardware component that may be a central processing unit (CPU), a semiconductor-based microprocessor, and/or other hardware devices suitable for retrieval and execution of instructions stored in machine-readable storage medium 204. Processor 202 may fetch, decode, and execute instructions 206, 208, 210, and 212 to control a process of creating a report relating to CQMs. As an alternative or in addition to retrieving and executing instructions, processor 202 may include at least one electronic circuit that includes electronic components for performing the functionality of instructions 206, 208, 210, 212, or a combination thereof.

Machine-readable storage medium 204 may be any electronic, magnetic, optical, or other physical storage device that contains or stores executable instructions. Thus, machine-readable storage medium 204 may be, for example, Random Access Memory (RAM), an EPROM, an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with a series of processor executable instructions 206, 208, 210, and 212 for receiving CQM data and encounter data associated with at least one medical encounter, determining that the CQM data is associated with the encounter data, generating an association between the CQM data and the encounter data, accessing a set of criteria defined by a clinical quality performance management program, identifying that the CQM data and the encounter data fulfill the set of criteria, and creating a report identifying potential eligibility for an incentive or disincentive based on the CQM data and the encounter data.

Extractor instructions 206 may manage and control the receipt of CQM data and encounter data from any entities providing such data, such as health care providers and/or patients. Extraction instructions 206 may determine which CQM data is associated with which encounter data and may generate an association between any corresponding data. Extraction instructions 206 may determine which data is associated based on any corresponding data specified by the CQM data and the encounter data, such as a patient name, patient identification number, date and/or time of medical encounters, location of medical encounters, medical staff name, and the like. Extraction instructions 206 may generate an association between corresponding data in any suitable manner, such as by specifying the association in metadata associated with the CQM data and the encounter data.

Quality assessment instructions 208 may manage and control the assessment of associated CQM data and encounter data. For example, quality assessment instructions 208 may access a set of criteria defined based on a clinical quality performance management program, determine whether CQM data and the associated encounter data fulfill the set of criteria, and identify any data that meets the set of criteria. The set of criteria may be any suitable criteria based on the corresponding clinical quality performance management program. For example, an incentive may be offered by a government institution to any health care providers and/or payers if a specified event occurs within a particular amount of time (e.g., time-based incentive based on a temporal rule), if the specified event occurs at all (e.g., binary-based incentive based on a binary rule), and the like. In some examples, an incentive may be offered based on a sliding scale such that the amount of the incentive varies based on a sliding scale rule (e.g., the amount of an incentive may increase as certain events occur). In some examples, the set of criteria may be fulfilled based on a specified threshold amount of time. For example, the set of criteria may specify that within 48 hours of a pediatric visit, the rendering health care provider is to execute an order for a particular culture, where the set of criteria may specify a threshold amount of time of 30 minutes such that the set of criteria may be considered fulfilled if the order for a particular culture is executed within 48 hours, plus or minus 30 minutes.

Reporting instructions 210 may manage and control reporting of any data that fulfills the set of criteria managed by quality assessment instructions 208, including managing and controlling the scheduling and generating of reports and communications for any clinical quality performance management programs defined by quality assessment instructions 208. For example, reporting instructions 210 may create a report identifying any potential eligibility for incentives based on any CQM data and encounter data that fulfills the set of criteria. The reports generated by reporting instructions 210 may include any suitable data for any suitable number of medical encounters and/or patients. In some examples, the reports may be created based on rules associated with the particular clinical quality performance management program for which the set of criteria apply. For example, a report may be created that indicates encounters for a particular patient, an aggregate of encounters associated with any number of patients and/or for any time period (e.g., weekly report), and the like. In some examples, a report may be automatically generated and/or sent in any suitable manner (e.g., weekly, monthly, annually, etc.). Reports may be sent to the appropriate entity (e.g., government institution) based on the clinical quality performance management program.

Remittance instructions 212 may manage and control the receipt of any determination of potential eligibility for any incentives in response to any reports sent to the appropriate government institution as well as any incentives received. For example, remittance instructions 212 may receive a determination that incentives are to be given based on a report sent and/or may receive the incentives themselves. Remittance instructions 212 may also store any incentive data associated with incentives received and/or denied in a historical repository, which may be a storage medium storing historical data associated with incentives. Remittance instructions 212 may also generate notifications of any specific payment outcomes associated with incentives.

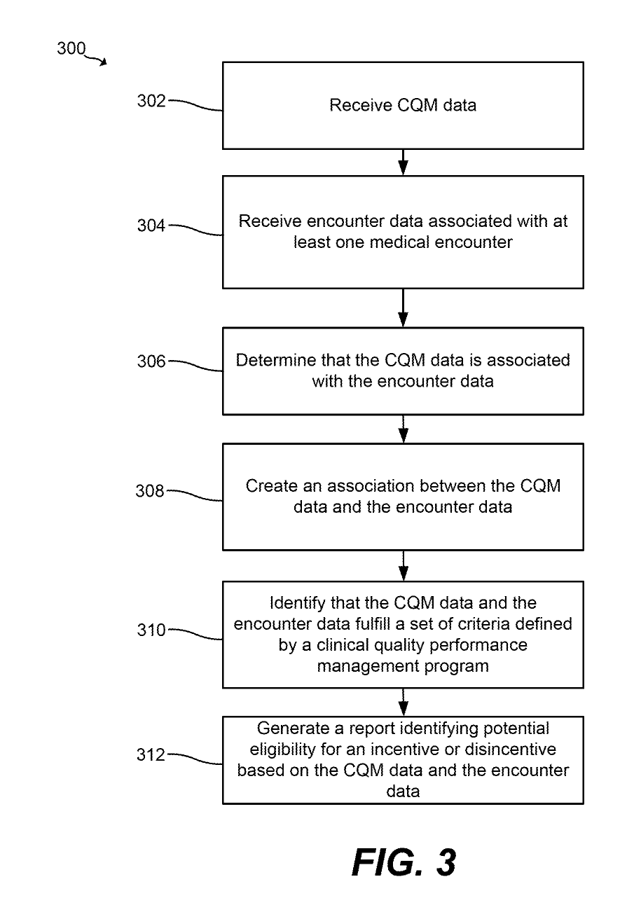

FIG. 3 is a flowchart of an example method 300 for generating a report relating to CQMs. Method 300 may be implemented using computing device 200 of FIG. 2.

Method 300 includes, at 302, receiving CQM data. The CQM data may be received from any suitable entity, such as a health care provider.

Method 300 also includes, at 304, receiving encounter data associated with at least one medical encounter. The encounter data may be received from any suitable entity, such as a health care provider, a patient, and the like.

Method 300 also includes, at 306, determining that the CQM data is associated with the encounter data. The association may be determined in any suitable manner (e.g., CQM data and encounter data with matching patient information, encounter data, etc.).

Method 300 also includes, at 308, creating an association between the CQM data and the encounter data. The association may be created in any suitable manner (e.g., specifying the association in metadata for the CQM data and/or the encounter data).

Method 300 also includes, at 310, identifying that the CQM data and the encounter data fulfill a set of criteria defined by a clinical quality performance management program. The set of criteria may specify various criteria that the CQM data and/or encounter data are to meet in return for incentives or disincentives.

Method 300 also includes, at 312, generating a report identifying potential eligibility for an incentive or disincentive based on the CQM data and the encounter data. The report may be sent to the appropriate entity associated with the clinical quality performance management program such that the entity may provide incentives or disincentives accordingly.

Examples provided herein (e.g., methods) may be implemented in hardware, software, or a combination of both. Example systems may include a controller/processor and memory resources for executing instructions stored in a tangible non-transitory medium (e.g., volatile memory, non-volatile memory, and/or machine-readable media). Non-transitory machine-readable media can be tangible and have machine-readable instructions stored thereon that are executable by a processor to implement examples according to the present disclosure.

An example system can include and/or receive a tangible non-transitory machine-readable medium storing a set of machine-readable instructions (e.g., software). As used herein, the controller/processor can include one or a plurality of processors such as in a parallel processing system. The memory can include memory addressable by the processor for execution of machine-readable instructions. The machine-readable medium can include volatile and/or non-volatile memory such as a random access memory (“RAM”), magnetic memory such as a hard disk, floppy disk, and/or tape memory, a solid state drive (“SSD”), flash memory, phase change memory, and the like.

What is claimed is:

1. A computing device, comprising:
a processor to:
receive clinical quality measures (CQM) data;
receive encounter data associated with at least one medical encounter;
identify that the CQM data is associated with the encounter data;
determine that the CQM data and the encounter data fulfill a set of criteria defined by a clinical quality performance management program; and
generate a report identifying potential eligibility for an incentive or disincentive based on the CQM data and the encounter data.

2. The computing device of claim 1, wherein the processor is further to:
receive a determination of potential eligibility for the incentive or disincentive in response to the report.

3. The computing device of claim 1, wherein the processor is further to:
store incentive data associated with a participant of the clinical quality performance management program in a historical repository.

4. The computing device of claim 1, wherein the set of criteria includes at least one of a temporal rule, a binary rule, and a sliding scale rule.

5. The computing device of claim 1, wherein the CQM data is received from a health care provider.

6. The computing device of claim 1, wherein the encounter data is received from a health care provider or from a patient.

7. The computing device of claim 1, wherein the report is generated automatically by the computing device of a health care payer.

8. A method, comprising:
receiving, by a computing device, clinical quality measures (CQM) data;
receiving, by the computing device, encounter data associated with at least one medical encounter;
determining, by the computing device, that the CQM data is associated with the encounter data;
creating, by the computing device, an association between the CQM data and the encounter data;
identifying, by the computing device, that the CQM data and the encounter data fulfill a set of criteria defined by a clinical quality performance management program; and
generating, by the computing device, a report identifying potential eligibility for an incentive or disincentive based on the CQM data and the encounter data.

9. The method of claim 8, further comprising:
receiving, by the computing device, a determination of potential eligibility for the incentive or disincentive in response to the report.

10. The method of claim 8, further comprising:
storing, by the computing device, incentive data associated with a participant of the clinical quality performance management program in a historical repository.

11. The method of claim 8, wherein the set of criteria includes at least one of a temporal rule, a binary rule, and a sliding scale rule.

12. The method of claim 8, wherein the CQM data is received from a health care provider.

13. The method of claim 8, wherein the encounter data is received from a health care provider or from a patient.

14. The method of claim 8, wherein the report is generated automatically by the computing device of a health care payer.

15. A non-transitory machine-readable storage medium storing instructions that, when executed by at least one processor of a computing device, cause the computing device to:
receive clinical quality measures (CQM) data and encounter data associated with at least one medical encounter;
determine that the CQM data is associated with the encounter data;
generate an association between the CQM data and the encounter data;
access a set of criteria defined by a clinical quality performance management program;
identify that the CQM data and the encounter data fulfill the set of criteria; and
create a report identifying potential eligibility for an incentive or disincentive based on the CQM data and the encounter data.

16. The non-transitory machine-readable storage medium of claim 15, wherein the instructions further cause the computing device to receive a determination of potential eligibility for the incentive or disincentive in response to the report.

17. The non-transitory machine-readable storage medium of claim 15, wherein the instructions further cause the computing device to store incentive data associated with a participant of the clinical quality performance management program in a historical repository.

18. The non-transitory machine-readable storage medium of claim 15, wherein the set of criteria includes at least one of a temporal rule, a binary rule, and a sliding scale rule.

19. The non-transitory machine-readable storage medium of claim 15, wherein the CQM data is received from a health care provider.

20. The non-transitory machine-readable storage medium of claim 15, wherein the encounter data is received from a health care provider or from a patient.
